(19) United States
(12) Patent Application Publication
(10) Pub. No.: US 2017/0221308 A1
(43) Pub. Date: Aug. 3, 2017

(54) BETTING SYSTEM

(71) Applicant: Bhavesh Lakhotia, Jodhpur (IN)

(72) Inventor: Bhavesh Lakhotia, Jodhpur (IN)

(21) Appl. No.: 15/172,452

(22) Filed: Jun. 3, 2016

(30) Foreign Application Priority Data
Feb. 1, 2016 (IN) 201611003517

(51) Int. Cl. G07F 17/32

(52) U.S. Cl. CPC G07F 17/3258; G07F 17/3288; G07F 17/3246; G07F 17/3251; G07F 17/3211; G07F 17/323

(57) ABSTRACT

A pool betting system is disclosed, which allows betting to take place before an event, as in a traditional pool, and also provides for a secondary market in bets during the event. For example, players may bet on the highest scoring batsman in a game of cricket. Bets are placed and the pool is closed before play begins, but during the game players can change their position by buying and selling bets from other players. This allows in-play participation without adversely affecting the interests of non-participating players.

The present invention relates to a betting system, and in particular a pool betting system which allows users to place bets or cash-in bets during play.

### BACKGROUND TO THE INVENTION

Pool betting is well known, and bookmakers offer betting pools covering a wide range of events, especially sports. Even in a single sporting event, different pools are offered covering a range of aspects of the game—for example, in a game of football a pool might be offered for the overall final score in the game, for the first player to score, for the first player to receive a yellow card etc. In general, pool betting involves players predicting the outcome of an event or series of events, before the event begins. Players' stakes are put into the pool against the outcome on which they bet, and when the result is known the total amount in the pool will be paid out to those who correctly predicted the outcome, minus a percentage fee charged by the bookmaker.

Although there are no ‘odds’ advertised at the time the bet is placed, the effective odds on a particular bet depend on the number of other players who have bet for or against a particular outcome. A player who bets on an “unpopular” outcome (unpopular in the sense that not many other players bet on that outcome) stands to win more if his prediction proves correct, because a larger part of the total pool size will have been paid in by other players. On the other hand, a player who bets on a favourite outcome (i.e. an outcome which many other players have bet on as well) will stand to win a smaller amount. If a majority of players all bet on the same outcome, and that outcome turns out to be the winner, then most players will win, but most of the prize money will be the stakes paid by those players in the first place.

It is critical to the fair running of a pool betting system that bets are not allowed to be placed once the event has begun. A player who takes a risk and bets on an unpopular outcome would stand to have his reward reduced if other players were allowed to bet on the same outcome after the start of play (for example, when the unlikely team has scored a goal).

The lack of availability of in-play pool betting is however in some respects a disadvantage, since in-play betting can heighten the excitement of the gambling game and of the event itself.

U.S. Pat. No. 8,602,884 discloses a pool betting system for “multi-leg” events. A multi-leg event is effectively a group of separable events, which depending on the context could be separate parts of a single sporting event (for example each day of a test match in cricket) or alternatively a number of different sporting events (for example all the football games to be played in a week or in a season). The multi-leg pool betting system in US′884 identifies players who might still win after each leg, i.e. those players whose predictions so far have been correct. These players are then offered the opportunity to “cash-out” and receive an amount of money in exchange for leaving the game and losing the opportunity to win the full amount if all of their predictions prove to be correct in the future legs. Alternatively, the player can choose to stay in the game and retain the opportunity to win a larger amount if more predictions prove correct, but will not win anything if one of their future predictions is wrong.

The system of US'884 to a limited extent allows ‘in-play’ participation, in that players can change their position by “cashing out” during a multi-leg event, between legs. However, it does not allow true in-play betting while a leg is in progress.

The bookmaker running a pool betting system generally takes a percentage of the pool to cover its operating costs and make a profit. The industry is competitive, and players are always looking for the best price for a bet. Bookmakers are therefore looking for ways to be more competitive while remaining profitable.

It is an object of the present invention to facilitate in-play pool betting, while protecting the interests of players. It is a further object of the invention to provide the bookmaker with alternative charging structures to the traditional percentage take from the pool.

### STATEMENT OF INVENTION

According to the present invention, there is provided a pool betting system comprising at least one user terminal for allowing placement of bets, at least one display device for displaying information about bets, and a system control server configured to communicate with the or each user terminal and the or each display device,
the system control server including an event control input and being adapted to:
   initialize an event pool including a plurality of possible event outcomes, an event starting criterion and an event ending criterion;
   monitor the event control input to determine whether the event starting criterion and the event ending criterion has been met;
   while the event starting criterion has not been met:
      accept and record bets from user terminals, each bet including information identifying the user, an amount, and a chosen outcome selected from the plurality of possible outcomes;
      maintain totals of the amount bet against each possible event outcome;
      transmit the totals of the amount bet against each possible event outcome to the display device(s);
   and while the event starting criterion has been met and the event ending criterion has not been met:
      accept bids to buy bets from user terminals, each bid including information identifying the user, an amount, a chosen outcome selected from the plurality of possible outcomes, and a bid price;
      accept offers to sell bets from user terminals, each offer including information identifying the user, an amount, a chosen outcome selected from a plurality of possible outcomes, and an offer price;
      maintain records of pending bids and offers;
      match offers and bids, and execute transfers of bets to fulfil matched bids and offer by updating the record of bets to transfer ownership of bets from the offering user to the bidding user;
      transmit the bid/offer price and amount of at least some pending bids and offers to the display device(s).

In the system of the invention, users can place bets before the event in question has begun, in much the same way as a conventional pool betting system. Once the event has begun the pool is ‘closed’, in that no further money can be placed into the pool. The total amount in the pool is generally fixed and the total amount bet against each possible outcome is also fixed. This ensures that the interests of all players are protected, whether or not they participate in the bid/offer system during play.

However, unlike conventional pool betting, players have the opportunity to continue to participate while the event is in progress. For example, if a player has bet on a particular outcome (for example, team A to win) and team A's performance some way through the game is worse than expected, so that it looks like a win for team A is very unlikely, the player might chose to ‘cut his losses’ by offering his bet for sale on the marketplace. Since his team's performance has been poor, the player will expect to sell his bet for less than his original stake, but by doing so he at least recovers some of his money, all of which he will lose if he maintains his position and team A do in fact lose.

Conversely, if it appears to a player that his team is performing better than expected, then he might chose to ‘bank’ a gain by offering his bet for sale on the marketplace. The player can expect to achieve a price for his bet which is more than he originally paid, although it will not be as much as he would win if he retained his position throughout the event and his team did in fact win.

Likewise, a player who feels that a team's performance so far has been underestimated by other players, or who believes that a team can recover from apparently poor performance and still win the game, has an opportunity to purchase bets on the marketplace for below the price of the original stake. A player who does this stands to win proportionally more if his prediction proves correct, and the ‘undervalued’ team eventually wins the event.

Throughout the event, players can buy and sell bets from each other, taking account of the performance of teams (for example) so far and their up-to-the minute predictions as to which outcome(s) appear likely. Different players may feel at a particular time that particular outcomes are under- or over-valued, and can bid or offer as they see fit. This allows players to actively participate in the pool throughout the duration of the event, making the betting experience more involved and more interesting. At the same time, the in-play transfer of bets provides a potential additional stream of income for the system operator, since commission can be charged on transfers. All of this allows the operator to provide a more competitive offering whilst maintaining its profitability.

The user terminal(s), display device(s) and server may communicate with each other over a packet switched network, for example the Internet or a private IP network. The user terminal(s) may be, for example, personal computers, laptops, tablets, smartphones etc.

Preferably the display device is a projector or another type of large-format display. Ideally, the current status of the pool and/or details of the currently-pending bids/offers are displayed at the location where the event is taking place (e.g. a sports stadium). Pool status and bid/offer details may also be made available via user terminals and/or other display means.

The user terminal(s) may include a payment acceptance device. This may be in the form of a bill acceptor and/or a coin acceptor, or a card reader, which may include an NFC (near field communication) card reader, or any other form of payment acceptance device.

User terminals may also include a payment dispensing device, so that winnings can be automatically dispensed to winning players. Again, the payment dispensing device may be in the form of a coin and/or bill dispenser, a card reader, possibly an NFC (near field communication) card reader, or any other means of dispensing payment to a winning player.

It is envisaged that user terminals with payment dispensing devices in the form of coin or bill acceptors/dispensers may be installed in public locations, for example at sports stadiums. In some embodiments, it may be possible for a user to place his bet on one user terminal, for example his smartphone, and collect his winnings on another user terminal, for example a public terminal with a payment dispensing device.

The server may be further adapted to maintain a record of the highest-price pending bid, the lowest-price pending offer, the aggregate amount of all pending offers at the price of the lowest-price pending offer, and the aggregate amount of all pending bids at the price of the highest-price pending bid.

Maintaining a record of this information allows bids and offers to be matched quickly to execute transactions. Some of this information may also be displayed to users via the display device or via user terminals, so that the users can see what sort of bid or offer is likely to be matched immediately. A user may preferably be provided with an ‘instant buy’/‘instant sell’ option, to buy or sell bets in a certain outcome at the best currently-available price.

A bid/offer matching process is preferably executed on the server each time a bid is accepted from a user terminal, the matching process comprising the steps of:
a. comparing the accepted bid to pending offers, and determining whether the accepted bid price is greater than or equal to the lowest-price pending offer;
b. if the accepted bid price is greater than or equal to the lowest-price pending offer, then executing a transfer at the price of the lowest-price pending offer;
c. otherwise, recording the accepted bid as a pending bid.

Every time a bid comes in, matching will be attempted. If the bid price is at least as much as the lowest-price pending offer, then a transaction can be executed immediately, because a seller is willing to sell at less than the bid price. On the other hand, if the bid price is less than the lowest-price pending offer, then a transaction cannot be executed because no seller is willing to sell for the bid price or less. In this case, the bid is recorded as a pending bid, and may be matched at a later time if a sufficiently low-priced offer is received.

The matching process may further comprise the following steps, when the accepted bid price is greater than or equal to the lowest-price pending offer:
a. comparing the amount of the accepted bid with the total aggregate amount of pending offers at the price of the lowest-price pending offer;
b. if the total aggregate amount is greater than or equal to the amount of the accepted bid, executing a transfer at the price of the lowest-price pending offer and the amount of the accepted bid;
c. otherwise, executing a transfer at the price of the lowest-price pending offer and the amount of the total aggregate amount of pending offers at the price of the lowest-price pending offer, reducing the amount of the accepted bid by the amount of the transaction, and repeating the matching process treating the reduced-amount bid as a new accepted bid.

This matching process ensures that a bidder will be able to buy bets for the best available price on the market, regardless of the amount of his bid. As an example, a bidder might bid $2 per bet, for 100 bets. There may be, for example, pending offers for 10 bets at $1, 50 bets at $1.50, 30 bets at $2 and 10 bets at $2.50. In the matching process, the bidder's bid will be matched initially to the $1 offer and a transaction executed for 10 bets at $1. The amount of the bid will then be reduced to 90 bets at $2 per bet and the matching process repeated. At this stage, the 50×$1.50 offer will be matched, and a transaction executed for 50 bets at $1.50. The amount of the bid will be reduced again to 40 bets, and the matching process repeated. In the third iteration the offer of 30×$2 will be matched, and a transaction for 30 bets at $2 is executed. The amount of the bid will be reduced to 10 bets, and the matching process repeated. The bid is now 10 bets for $2 each, but there are no pending offers for $2 or less, and so the remainder of the bid will be recorded as a pending bid. If an offer is received at a later time at a price of $2 or less, then it will be matched to the pending bid.

Executing a transaction at a transaction price and a transaction amount may comprise the steps of:
a. updating the record of bets to transfer ownership of bets from one or more originators of pending offers to the originating user of the accepted bid;
b. updating the record of pending offers to reduce the amount of or remove altogether the executed pending offer(s);
c. initiating a payment from the originating user of the accepted bid to the originating user(s) of the executed pending offer(s).

Payment for the transaction may be accepted via a payment acceptance device and dispensed via a payment dispensing device, examples of which are discussed above.

An analogous process is preferably executed each time an offer is accepted from the user terminal, the matching process comprising the steps of:
a. comparing the accepted offer to pending bids, and determining whether the accepted offer price is less than or equal to the highest-price pending bid;
b. if the accepted offer price is less than or equal to the highest-price pending bid, then executing a transfer at the price of the highest-price pending bid;
c. otherwise, recording the accepted offer as a pending offer.

The process ensures that the seller making an offer will achieve the highest price available in the marketplace at the time, in the same way that a buyer placing a bid will buy for the lowest price available at the time. However, a pending bid or pending offer, if it is matched and executed, will be executed at the actual price of the pending bid/offer—never less than the bid price or more than the offer price.

When the accepted offer price is less than or equal to the highest-price pending bid, the matching process may further comprise the steps of:
a. comparing the amount of the accepted offer with the total aggregate amount of pending bids at the price of the highest-price pending bid;
b. if the total aggregate amount is greater than or equal to the amount of the accepted offer, executing a transfer at the price of the highest-price pending bid and the amount of the accepted offer;
c. otherwise, executing a transfer at the price of the highest-prince pending bid and the amount of the total aggregate amount of pending bids at the price of the highest-price pending bid, reducing the amount of the accepted offer by the amount of the transaction, and repeating the matching process treating the reduced-amount offer as a new accepted offer.

Again, this process ensures that the seller making an offer will achieve the best possible price, even if the highest-price pending bid is for an amount (quantity of bets) which is less than the amount of the offer.

It may be that at a particular time, there are multiple pending offers or pending bids in the system which could potentially be matched to an accepted bid or accepted offer. In this case, typically a ‘first-in-first-out’ procedure will be followed, where pending bids/offers are matched and executed in order to their time of receipt. Typically therefore, the time of receipt of a bid or offer is noted and recorded when the bid/offer is accepted into the system.

The “best pending offer price” (i.e. the highest pending offer price) and the “best pending bid price” are preferably displayed via the display device at all times. Users may be provided with the facility to place “buy at best price” or “sell at best price” orders which are treated as bids at the best pending offer price, or offers at the best pending bid price respectively.

A number of “buy at best price” or “sell at best price” orders can be combined into a “composite order”. A simple example of a composite order is a negation composite, made up of all but one of the bets from the pool, with the proportion of the amounts of each bet in the composite being the proportion of the pool size for each bet. In other words, a negation composite is a bet made against a particular outcome.

In order for a composite order to work as intended, the whole order needs to execute. Because the composite order is made up of “buy at best price” or “sell at best price” orders, in theory the order should always execute. However, if a price changes between the order being placed and it being accepted into the matching process, then execution may not be possible. In this case the whole composite order is cancelled and the user will be presented with a new price and can place the order again it he wishes to do so.

In some embodiments, the operator may wish to add a ‘bonus’ to the pool. A bonus is likely to lead to a change in prices, and so users are preferably provided with the option to automatically cancel any pending bids or pending offers, when any bonus is added. The display may include a timer to indicate the time remaining until a bonus will be added to the pool.

An API (application programming interface) may be provided to the system control server, allowing programmatic support for placing bids and offers.

The betting system can work with different types of pool betting, across a wide range of different underlying events. To give just two examples, in cricket one example of a pool bet is a pool for the highest scoring batsmen. Before the beginning of the innings, users place bets on a batsman or a number of batsmen. When play begins, the pool closes, but players can buy and sell bets from each other on the secondary market, during play. As each batsman plays and scores, and as wickets fall, the prices on the secondary market are likely to change fairly dramatically. This adds to the excitement of the betting game. At the end of play, the pool (minus any take from the bookmaker) is divided (for example) among the bets for the two highest run scorers, in proportion to the number of runs scored.

Another example is horse racing. Conventionally, once the pool is closed, just before the race begins, odds are displayed. Players unsatisfied with the odds have the option to sell their bets on the secondary market. Likewise, players who missed betting are given the chance to take part. Although a horse race typically does not last as long as a game of cricket, buying and selling of bets can still take place during the race, and prices will change as horses pull ahead or fall behind. This all adds to the betting experience for players.

The system of the invention is especially useful for events lasting long periods, such as test cricket and seasonal pools. Also, for pool betting where the payout is based on a metric that is highly volatile, the invention provides a new and entertaining way to gamble, as the prices will fluctuate much more than conventional fixed-odds betting, as these volatile systems are very difficult to price correctly.

The pool betting system may also be applied to the operation of a fantasy league game, in which teams are chosen by players and points are awarded based on team performance. In a fantasy league using the betting system of the invention, the points are set up as a pool of points to be distributed to the winners, and players have the option of changing their selections by participating in a secondary market, while the underlying event is taking place.

### DESCRIPTION OF THE DRAWINGS

For a better understanding of the present invention, and to show more clearly how it may be carried into effect, preferred embodiments will now be described with reference to the accompanying drawings, in which:

FIG. 1 shows a schematic of a system according to the invention,

FIG. 2 shows an example of information displayed on the display device in an embodiment of the system of the invention;

FIG. 3 is a flowchart illustrating the matching process for received bids;

FIG. 4 is a flowchart illustrating the matching process for received offers; and

FIG. 5 is a schematic of a database structure suitable for storing active bids and active offers.

### DESCRIPTION OF A PREFERRED EMBODIMENT

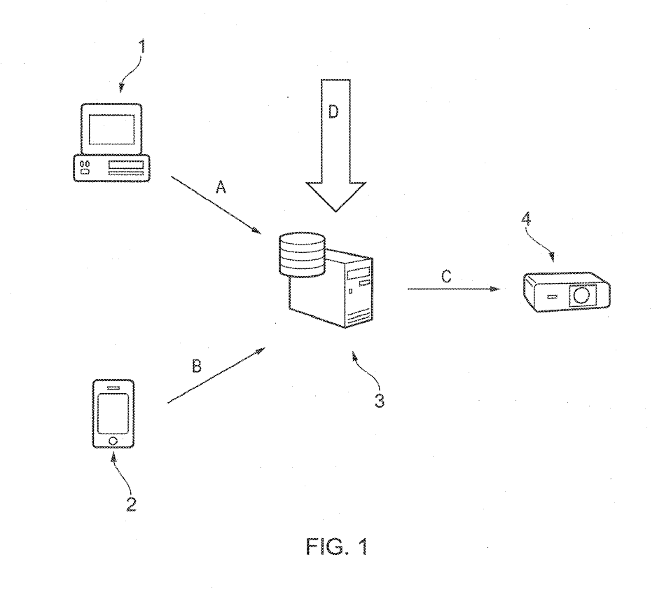

Referring firstly to FIG. 1, a general schematic of a system according to the invention is shown. The system includes user terminals 1, 2, which in this example are shown in the form of a desktop PC 1 and a mobile telephone 2. Other types of user terminals, for example special-purpose public access kiosks, may also be provided. The user terminals 1, 2 communicate with system control server 3. Arrows A and B show the flow of information in the form of bets placed before the event begins, and of bids and offers made during the event, from the user terminals 1, 2 to the system control server 3. It is understood that communications may in fact be bi-directional, not least to acknowledge messages received by the system control server 3. Arrow C shows the flow of information from the system control server 3 to the display device 4, which in this case is a projector. A projector or other large-format display is preferred, for displaying information in, for example, a sports stadium.

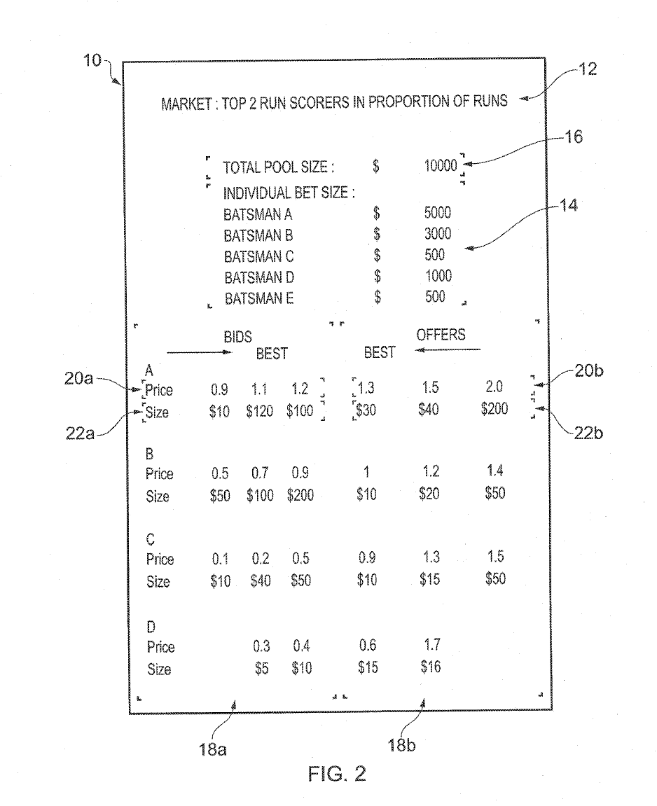

With reference to FIG. 2, an example display on a large-format display screen forming part of the betting system of the invention is indicated at 10. At the top of the display, a description 12 of the pool is displayed. In this example, the event is a game of cricket and the pool is for the top two run scorers in proportion of runs scored. The outcomes which are available for betting are therefore names of batsmen on both teams.

A list of outcomes (in this case names of batsmen) is displayed at a position 14 just below the pool description 12. Before the event (game of cricket) begins, players can place bets on their preferred batsman or batsmen, and their stake will be added to the pool. The amount bet against each individual outcome is displayed alongside the list of outcomes, indicated at 14b in the Figure.

The total pool size (i.e. the aggregate of all stakes paid in) is also displayed, indicated at 16. Before the event, as players place their stakes on preferred outcomes, the amounts bet against each outcome and the total pool size will be continually updated. When the event begins, these figures are ‘frozen’ since no further bets can be placed. At the conclusion of the event when the outcome is known, the total pool (in the example $10000) will be divided amongst winning players in proportion to the number of runs scored by the top two players. For example, if the top run scorers are Batsman A and Batsman C, scoring 20 and 15 runs respectively, then $5714 will be divided among the players who bet on Batsman A, and $4286 will be divided among the players who bet on Batsman C. It will be noted that in the case of Batsman A, who was always expected to perform well and attracted a large number of bets, the payout is only a little more than the stake originally placed. In the case of Batsman C, who was not thought to be a likely top-run-scorer, the payout is around 8.5 times the stake.

The operation of the pool before the event begins and after the event ends is in all material respects the same as a conventional pool betting system. Indeed, a player can choose to place a bet before the game begins, not participate in the ‘in play’ market, and therefore use the system in a conventional way. Such a player will not be prejudiced by the operation of the ‘in game’ market, and in fact may benefit from a lower ‘take’ removed from his winnings by the bookmaker, since the bookmaker has an alternative source of income in running the ‘in play’ market and can therefore charge a more competitive basic fee.

In the lower part of the example display screen in FIG. 2, information about the operation of the ‘in play’ market is displayed. In particular, the three best (i.e. highest price) pending bids 18a and the three best (i.e. lowest price) pending offers 18b are listed. The price is listed in terms of a multiplier of the original stake 20a, 20b, and the size of the bid/offer (i.e. the size of the stake of the original bet which is offered for transfer) is also displayed at 22a, 22b. In this example, it appears that players are of the opinion that batsmen B, C and D are performing badly, or at least are unlikely to be in the top two run scorers, since the best price bid for bets against those players is less than the original stake. On the other hand, players are prepared to pay 1.1 or 1.2 times the original stake for bets on batsman A.

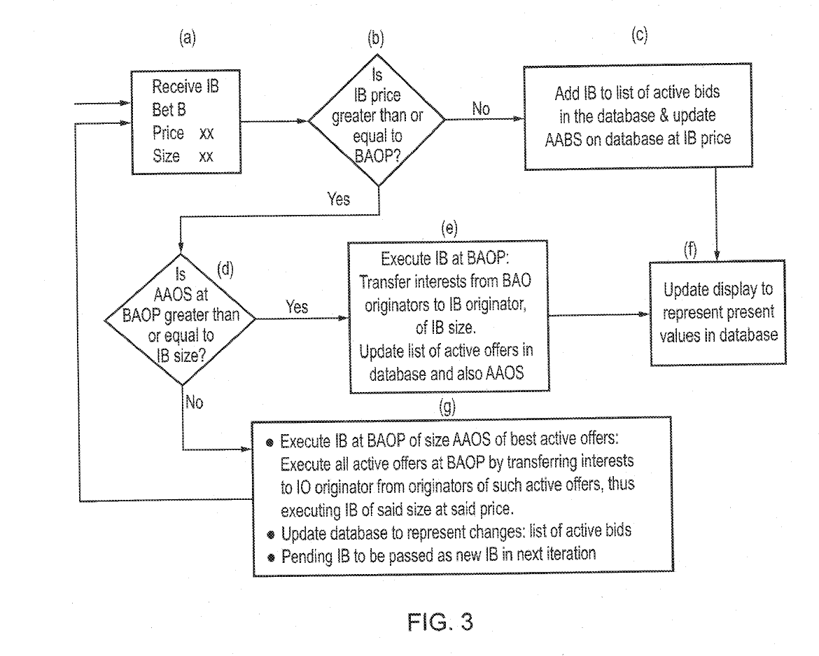

FIG. 3 is a flow chart illustrating the matching process for accepted bids in detail. At step (a), an Input Bid (IB) is received/accepted into the server. The bid will specify an outcome (in this case batsman B), a bid price and a bid size/amount. At step (b) a comparison is carried out between the Input Bid price and the Best Active Offer Price (BAOP). The BAOP is the price of the lowest-priced pending offer. If the IB price is at least as much as the BAOP, then the process proceeds to step (d). Otherwise, step (c) is the next step.

In step (c) (when the IB price is less than the BAOP), the IB is recorded in the database as an active/pending bid. The Aggregate Active Bid Size (AABS) is also updated to take account of the new active/pending bid. The process then proceeds to the final step (f).

In step (d) (when the IB price is at least the BAOP), a comparison is carried out between the Aggregate Active Offer Size (AAOS) at the BAOP. If the AAOS at BAOP is at least the IB size, then the process proceeds to step (e). Otherwise, the next step is step (g).

In step (e) (when the AAOS at BAOP is at least the IB size), a transfer is executed. The transfer is from the Best Active Offer originator(s) to the IB originator. The transfer is executed at price BAOP and at the size specified in the Input Bid. The list of active/pending offers in the database is updated to remove the offer (or update the amount if only part of the offer has been exhausted) which has been matched and executed. The AAOS is also updated and the process then proceeds to step (f).

In step (g) (when the AAOS at BAOP is less than the IB size), a transfer is executed at BAOP, but the size/amount of bets transferred is smaller—the size is determined by AAOS at BAOP. All active/pending offers at BAOP are exhausted by transferring the bets/interests from the BAOP originator(s) to the originator of the IB. The database of active/pending offers is updated to remove the exhausted offers. The IB has now been partially executed, in that a transaction has taken place at less than the IB size. A new bid is then generated, at a size equal to the original IB size less the size executed, and this new bid is passed back into the system at step (a), the recursive process iterating and treating the new bid as the IB.

Step (f) is the final stage of the process. The process will always reach step (f), possibly after several recursions and either via step (c) or step (e). In step (f) the display is updated to show the currently pending bids and offers in the system.

Note that the words ‘pending’ and ‘active’ are used interchangeably to mean bids or offers which have been submitted but not yet matched and executed. ‘Interest’ and ‘bet’ are words used to describe the ‘betting ticket’ which a player has bought at the start of the game, and which can be bought and sold on the secondary market. The ‘size’ or ‘amount’ of a bet is the size of the stake originally paid, and the ‘price’ is the price of the transfer on the secondary market, which can be conveniently expressed as a multiplier of the original stake. When a bid or offer is ‘received’ or ‘accepted’ it means that a bid or offer is validly received by the server and entered into the matching process.

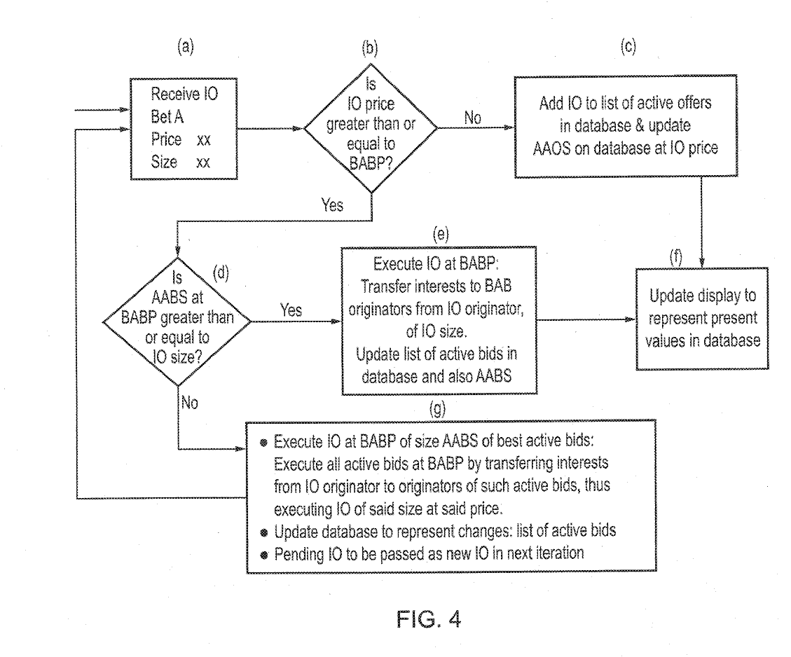

FIG. 4 is a flow chart showing an equivalent process for a received/accepted Input Offer (IO), which is received by the server in step (a). The Input Offer relates to a particular outcome (in this example Batsman A) and has a price and a size. In step (b) the IO price is compared with the Best (i.e. highest) Active Bid Price (BABP). If the IO price is less than or equal to the BABP, then the process proceeds to step (d). If the IO price is greater than the BABP, then step (c) is the next step.

In step (c) (when the IO price is greater than the BABP), no transaction can be immediately executed, and so the IO is added to the list of pending offers in the database and the Aggregate Active Offer Size (AAOS) is updated to reflect the IO price. The process then proceeds to the final step (f).

In step (d) (when the IO price is at least as low as the BABP), a comparison is made between the Aggregate Active Bid Size (AABS) at BABP, and the IO size. If the AABS at BABP is at least as much as the IO size, then the IO can be executed in full in step (e) of the process. Otherwise, the IO is executed in part at step (g).

In step (e), a transfer is executed to exhaust the IO in full. The transfer is at price BABP, the size is the IO size, and the transfer is from the originator(s) of the Best Active Bids to the IO originator. The database of active bids is updated to remove or reduce the partially and fully executed and exhausted active bids, and the record of the AABS is also updated. The process then proceeds to final step (f).

In step (g), a transfer is executed to partially exhaust the IO. The price of the transfer is BABP and the size is AABS. The database is updated to remove or reduce the partially and fully executed and exhausted active bids, and the record of the AABS is also updated. A new offer is then generated which is the same as the IO, but with the size reduced by the size of the executed transfer. The new offer is fed back into step (a) of the process where it is treated as an Input Offer.

The process may recurse several times, but will always eventually reach either step (c) or step (e), and will then reach final step (f). In step (f) the display is updated to reflect the up-to-date values in the database.

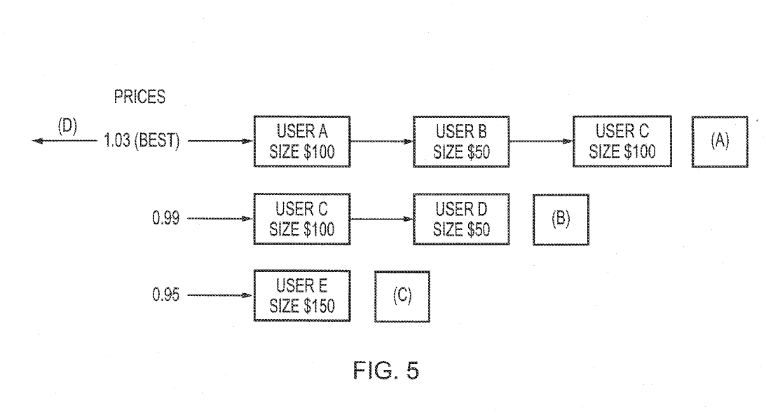

FIG. 5 illustrates a data structure which is ideal for recording pending bids and offers. In this case, a structure for pending bids is shown, but the features of an analogous structure for pending offers will easily be appreciated.

All of the bids at a particular price are stored in a linked list. The linked list at each price is in the order in which the bids were originally received. Therefore the bid at the head of the list is the bid at that particular price which has been in the system for the longest time. Any new bids will be appended to the tail of the list, assuming that the new bid is at the same price of at least one existing bid in the system. If the new bid is at a new (distinct) price, a new linked list will be created. A record of each distinct price includes a pointer to the head of the list at that price, and a pointer to the best (i.e. highest) bid price is maintained at all times.

This structure is an efficient way of storing the bids, since the operations required in the running of the system are adding a new bid, which is simply appended to the tail of the appropriate list, finding the best active offer price, which simply involves following the BAOP pointer, and finding the earliest bid at a particular price, which is simply a case of following the pointer from the required price to the head of the list.

The betting system provides for a new concept in the field of pool betting, allowing participation in pool betting ‘in play’ for the first time.

1. A pool betting system comprising at least one user terminal for allowing placement of bets, at least one display device for displaying information about bets, and a system control server configured to communicate with the or each user terminal and the or each display device,
the system control server including an event control input and being adapted to:
initialize an event pool including a plurality of possible event outcomes, an event starting criterion and an event ending criterion;
monitor the event control input to determine whether the event starting criterion and the event ending criterion has been met;
while the event starting criterion has not been met:
accept and record bets from user terminals, each bet including information identifying the user, an amount, and a chosen outcome selected from the plurality of possible outcomes;
maintain totals of the amount bet against each possible event outcome;
transmit the totals of the amount bet against each possible event outcome to the display device(s);
and while the event starting criterion has been met and the event ending criterion has not been met:
accept bids to buy bets from user terminals, each bid including information identifying the user, an amount, a chosen outcome selected from the plurality of possible outcomes, and a bid price;
accept offers to sell bets from user terminals, each offer including information identifying the user, an amount, a chosen outcome selected from the plurality of possible outcomes, and an offer price;
maintain records of pending bids and offers;
match offers and bids, and execute transfers of bets to fulfil matched bids and offers by updating the record of bets to transfer ownership of bets from the offering user to the bidding user;
transmit the bid/offer price and amount of at least some pending bids and offers to the display device(s).

2. A pool betting system as claimed in claim 1, in which the user terminal(s), display device(s) and server communicate with each other over a packet switched network.

3. A pool betting system as claimed in claim 1, in which at least one display device is a projector.

4. A pool betting system as claimed in claim 1, in which at least one user terminal includes a payment acceptance device.

5. A pool betting system as claimed in claim 4, in which the payment acceptance device is a bill acceptor and/or a coin acceptor.

6. A pool betting system as claimed in claim 4, in which the payment acceptance device is a card reader.

7. A pool betting system as claimed in claim 6, in which the card reader is an NFC (near field communication) card reader.

8. A pool betting system as claimed in claim 1, in which at least one user terminal includes a payment dispensing device.

9. A pool betting system as claimed in claim 8, in which the payment dispensing device is a bill dispenser and/or a coin dispenser.

10. A pool betting system as claimed in claim 8, in which the payment dispensing device is a card reader.

11. A pool betting system as claimed in claim 10, in which the card reader is an NFC (near field communication) card reader.

12. A pool betting system as claimed in claim 1, in which at least one user terminal is a mobile telephone.

13. A pool betting system as claimed in claim 1, in which the server is further adapted to maintain a record of the highest-price pending bid, the lowest-price pending offer, the aggregate amount of all pending offers at the price of the lowest-price pending offer, and the aggregate amount of all pending bids at the price of the highest-price pending bid.

14. A pool betting system as claimed in claim 1, in which a bid/offer matching process is executed each time a bid is accepted from a user terminal, the matching process comprising the steps of:
a. comparing the accepted bid to pending offers, and determining whether the accepted bid price is greater than or equal to the lowest-price pending offer;
b. if the accepted bid price is greater than or equal to the lowest-price pending offer, then executing a transfer at the price of the lowest-price pending offer;
c. otherwise, recording the accepted bid as a pending bid.

15. A pool betting system as claimed in claim 14, in which the process of matching bids/offers, when the accepted bid price is greater than or equal to the lowest-price pending offer, further comprises the steps of:
a. comparing the amount of the accepted bid with the total aggregate amount of pending offers at the price of the lowest-price pending offer;
b. if the total aggregate amount is greater than or equal to the amount of the accepted bid, executing a transfer at the price of the lowest-price pending offer and the amount of the accepted bid;
c. otherwise, executing a transfer at the price of the lowest-price pending offer and the amount of the total aggregate amount of pending offers at the price of the lowest-price pending offer, reducing the amount of the accepted bid by the amount of the transaction, and repeating the matching process treating the reduced-amount bid as a new accepted bid.

16. A pool betting system as claimed in claim 15, in which executing a transaction at a transaction price and a transaction amount comprises the steps of:
a. updating the record of bets to transfer ownership of bets from one or more originators of pending offers to the originating user of the accepted bid;
b. updating the record of pending offers to reduce the amount of or remove altogether the executed pending offer(s);
c. initiating a payment from the originating user of the accepted bid to the originating user(s) of the executed pending offer(s).

17. A pool betting system as claimed in claim 1, in which a bid/offer matching process is executed each time an offer is accepted from a user terminal, the matching process comprising the steps of:
a. comparing the accepted offer to pending bids, and determining whether the accepted offer price is less than or equal to the highest-price pending bid;
b. if the accepted offer price is less than or equal to the highest-price pending bid, then executing a transfer at the price of the highest-price pending bid;
c. otherwise, recording the accepted offer as a pending offer.

18. A pool betting system as claimed in claim 17, in which the process of matching bids/offers, when the accepted offer price is less than or equal to the highest-price pending bid, further comprises the steps of:
a. comparing the amount of the accepted offer with the total aggregate amount of pending bids at the price of the highest-price pending bid;
b. if the total aggregate amount is greater than or equal to the amount of the accepted offer, executing a transfer at the price of the highest-price pending bid and the amount of the accepted offer;
c. otherwise, executing a transfer at the price of the highest-price pending bid and the amount of the total aggregate amount of pending bids at the price of the highest-price pending bid, reducing the amount of the accepted offer by the amount of the transaction, and repeating the matching process treating the reduced-amount offer as a new accepted offer.

19. A pool betting system as claimed in claim 18, in which executing a transaction at a transaction price and a transaction amount comprises the steps of:
a. updating the record of bets to transfer ownership of bets from the originating user of the accepted offer to the originating user(s) of one or more pending bids;
b. updating the record of pending bids to reduce the amount of or remove altogether the executed pending bid(s);
c. initiating a payment from the originating user(s) of the executed bids to the originating user of the accepted offer.
